(19) United States
(12) Patent Application Publication
(10) Pub. No.: US 2008/0277466 A1
(43) Pub. Date: Nov. 13, 2008

(54) METHOD AND SERVICE FOR LINKING AND SYNCHRONIZING WASHING SUBSCRIPTIONS WITH RFID TECHNOLOGY

(75) Inventors: Brian Nichols Dohm, New Prague, MN (US); Anthony Dean Force, Centennial, CO (US); Shawn Michael Koehnen, Prior Lake, MN (US)

Correspondence Address: HAMRE, SCHUMANN, MUELLER & LARSON, P.C., P.O. BOX 2902, MINNEAPOLIS, MN, 55402-0902, US

(73) Assignee: XpresSystems, Inc., New Prague, MN (US)

(21) Appl. No.: 12/118,404

(22) Filed: May 9, 2008

Related U.S. Application Data
(60) Provisional application No. 60/928,526, filed on May 9, 2007.

(51) Int. Cl. G06K 5/00

(52) U.S. Cl. 235/382; 235/380

(57) ABSTRACT

A method and service and computer program product to link and synchronize subscriptions to be used at multiple washing facilities. RFID technology is used in the method and service to keep track of active subscriptions and the types and prices of washing services that are available to the subscriber. In one embodiment, subscription and RFID tag information stored at the local washing facilities are linked together and stored in a host server. The host server will periodically synchronize data between all connected washing facilities so there is consistency as to the subscriptions, active RFID tags, and types and prices of washing services.

### FIELD

This disclosure relates generally to a method and a service to which washing facilities and customers can subscribe wherein multiple washing facilities can be linked and synchronized using a host server so that a customer desiring washing services can use a subscription to access and obtain services at any one of subscribing washing facilities.

### BACKGROUND

Car washing facilities usually have a kiosk whereby users can enter their request for a car wash and/or payment information using a user interface on an input device, such as a touchpad, as part of the kiosk. The kiosk communicates the customer's input information to a control station local to the car wash at which point the request is authorized or not but, if so, payment is accepted.

In some car washing facilities, the kiosk also incorporates a radio-frequency (RF) technology such as described in US Patent Application Publication 2004/0079799 A1 entitled SERVICE STATION CAR WASH to Symonds et al., and US Patent Application Publication 2006/0180647 A1 entitled RFID APPLICATIONS to Hansen. To pay for the car wash, a customer presents a radio frequency identification (RFID) tag which is read by the RF reader in or on the kiosk. An RF antenna then transmits the customer's information read from the RFID to a local processor that identifies the customer's account or other payment information to authorize the car wash. If a driver uses the same car wash facility all the time, this arrangement is satisfactory.

Most drivers these days, however, travel significant distances, even in urban settings. In the above scenario, the driver with the assigned RFID tag is able to obtain a car wash at only that one car wash facility. Currently, there is no method by which a driver using the same RFID tag can enter different car wash facilities. What is needed in the industry is an improved, user-friendly system and method using RF technology to activate and track a washing subscription service so that a customer is able to obtain washing services at multiple washing facilities. What is also needed is a method and system to track, link and synchronize the number and types of washing services and subscriptions available at a plurality of washing facilities.

### SUMMARY

An improved vehicle washing facility system and method of using the washing facility for use in multiple vehicle washing sites. The disclosed system and method facilitate the development of a large customer base that can utilize the functionality of the disclosed system and method at multiple sites, maintain functionality of the system in the event of a network outage, and improve operational efficiency thereby requiring minimal hardware capabilities at the local level.

The disclosed system and method preferably integrate the use of RF technology with the use of a host server and at least one local processor. In one embodiment, the disclosed system includes an RF transceiver configured to be in communication with a local processor in communication with a host server.

The host server includes a central data repository storing information related to customers, and a processor coupled to the data repository. The host server is responsible for all data processing required in maintaining accurate customer records, including subscriptions to washing services, that rely on billing requests and other criteria to determine status and subsequent ability to wash. The host server is also provided for an administrative web site, the web site being run by a central server that includes a server interface.

The local processor is configured to be in communication with the host server. The local processor includes a local data repository storing a subset of the information contained in the main data repository host server. The local processor facilitates in reading of the RFID tags, finding matching customer records, and activating the customer's appropriate wash type.

In one embodiment, the disclosed method includes uses a host server, and establishes a customer's account where the account is chargeable against stored financial information of a customer. A RFID tag unique to the customer is assigned and activated. Using the local processor and RF transceiver, the method further comprises automatically placing and receiving the RF information stored in the RFID tag that may be placed on the customer's vehicle, and then searching for matching data based on the RFID information. If a matching record is found, then proceeding with car wash activation; if no matching record is found, using the local processor, the method communicates with the host server and sends a query to the main data repository of the host server. The method further comprises the host server searching the main data repository for the matching data based on the RF information, and if a matching record is found, the host server transfers the matching record to the local processor which then activates the RFID tag to allow a car wash.

In another embodiment, the disclosed method uses the local processor, to establish a customer's account where the account is chargeable against stored customer's financial data. The local processor assigns and activates an RFID tag unique to the customer for use at a local facility in which the local processor is located. The local processor also communicates to host server to receive updated data from the host server, thereby synchronizing the main data repository with the local data repository by transferring updated data from the main data repository to the local data repository.

### BRIEF DESCRIPTION OF THE DRAWINGS

FIG. 1 is a block diagram of the system wherein a subscription of washing services using RFID technology at multiple washing facilities can be linked and synchronized in accordance with embodiments described herein.

FIG. 2 is a simplified flow chart of the process by which a local washing facility communicates with the host server to determine if a RFID tag is active.

FIG. 3 is a simplified flow chart of entering subscriber or RFID tag into a network from a washing facility.

FIG. 4 is a simplified flow chart of linking and synchronizing subscription and washing services among all washing facilities connected on a network and a host server.

### DETAILED DESCRIPTION

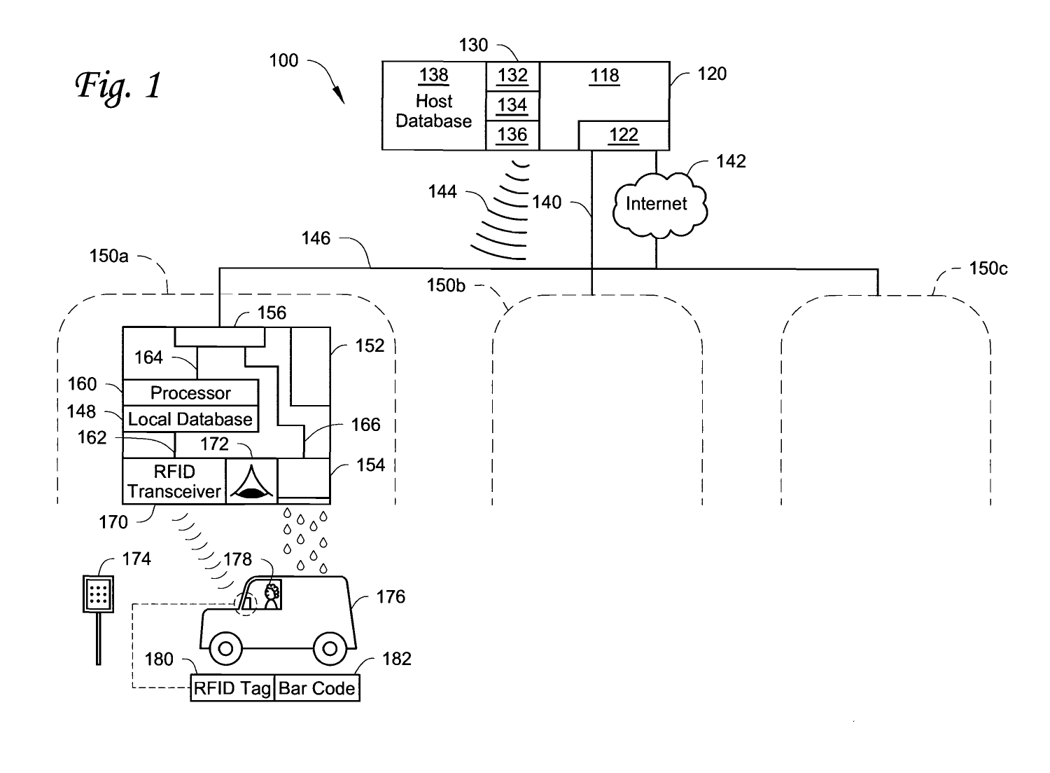

A networked system 100 of multiple local washing facilities 150a, 150b, 150c (herein referred to as washing facilities 150) is shown in FIG. 1. Each of the local washing facilities 150a, 150b, 150c are physically located at some distance away from one another. Washing facilities 150 preferably are vehicle washing facilities which may have the same or different washing equipment from each other, for instance, one of the washing facilities 150a may be a drive-through washing facility wherein the customer drives to a predetermined position in an enclosed space, does not exit the vehicle as the washing equipment moves along a track back and forth exterior to a vehicle during different wash and rinse cycles; usually having a dry cycle as the vehicle exits the enclosed space. Another instance of a washing facility 150b may be a full-service washing facility wherein the driver exits the vehicle and the vehicle is carried along a track to different wash and rinse stations. Washing facility 150c may be a self-service washing facility wherein the customer manually washes and rinses the vehicle using equipment, such as hoses and brushes, etc. that are preprogrammed having timed wash and rinse cycles and may use separate equipment to vacuum or wash the interior the vehicle. Examples of vehicle washing facilities that can take advantage of the linking and synchronization described herein may include, but are not limited to RYKO, PDQ, MACNEIL, MARK VII, BELANGER, WASHWORLD, JIM COLMEN Co., NUSTAR etc. Also, there may be a variety of the types of subscriptions offered such that different subscription plans may offer different washing services, or be of varying duration, or be associated with fleet accounts, be pre-paid or be billable, discounts may be offered based on frequency and the amount of washing services actually used, etc. A preferred embodiment to provide synchronization and linking services is that multiple subscriptions have a common owner, such as in fleet services or transportation services or other private company; alternatively or in addition the washing facilities may be commonly owned or licensed through a common franchise, although neither is a strict requirement.

While the kinds of washing services and equipment may vary, for purposes of linking and synchronization to be described herein, each washing facility 150 will have the same or similar hardware and software components to link and synchronize washing services as explained herein. To facilitate the explanation herein, only the linking and synchronization hardware and software components of one washing facility 150 will be described but the description applies to each washing facility 150.

Washing facility 150 has a processor 160, an RFID system that comprises a RF transceiver 170 with an integrated antenna, washing equipment 154, and one or more communication interfaces 156. Optionally, hardware and software components of the washing facility 150 may further include a kiosk 174, a barcode reader 172 and a local client or terminal 152, some of which may be connected by internal or external busses 162, 164, 166 or maybe in wireless communication with each other. The number of RF transceivers 170, RFID tags 180, and local processors 160 are not to be restricted to one of each; rather the number and kind of RFID systems will be dictated by the washing equipment and the circumstances. All the washing facilities 150, moreover, do not have to have to use the same RFID system as other washing facilities in the system, although when the RFID systems are the same, maintenance and replacement of the RFID systems, if necessary, are easier to accomplish. One example of a RFID system is the IDentity MaX system, available from Sirit, Inc. in Toronto, Canada.

RF transceiver 170 transmits and receives radio frequency signals at the washing facility 150 to read and/or read/write data to an RFID tag 180, also called an RF transponder. RFID tag 180, preferably, is a passive tag that has no moving parts and no batteries but does have a read/write memory. Passive RFID tags work well in temperature extremes and chemical or corrosive environmental conditions, such as can occur in washing facilities or on the exterior of a vehicle. Passive RFID tags, moreover, are typically smaller, less expensive, and have a useful read range of approximately thirty feet (about nine meters). RFID tag 180 is preferably encased within a flexible, lightweight, corrosive-resistant material that may have an adhering surface so that the RFID tag 180 may be mounted on either the inside or outside of a vehicle 176. A good place for the RFID tag 180 on a vehicle 176 is adhesively mounted on the bottom inside windshield, preferably out of the driver's line-of-sight. The RFID tag 180 may actually be mounted anywhere on or in the vehicle 176. Preferably, the RFID tag 180 is made from a material causing removal of the tag to be very difficult and/or unusable upon removal. The RFID tag 180 may also be associated with a customer, rather than a vehicle. When associated with a customer, the RFID tag 180 can be in the form of a smart card that can be carried on a person or in her/his belongings.

Services provided at the washing facility 150a further minimize any security threats such as the risk of cloning ant tampering. The RF transceiver 170 may be physically secured and its settings can be changed only be logging using a secure interface or website that may further be encrypted. The RFID tags 180 may have a digital identifier, such as a randomly-generated 96 bit identifier, that makes it all but impossible for someone to guess or alter the RFID tag 180. Certain fields in the memory of the RFID tag 180 may be “read only” fields so that they cannot be reprogrammed. The host service provider, moreover, may provide a monitoring service whereby certain events are monitored, such as when a subscription or RFID tag 180 has been used more than a configurable threshold.

As mentioned, the RF transceiver 170 transmits and receives radio frequency signals at the washing facility 150 in order to read and/or read/write data to an RFID tag 180. RF transceiver 170 generates an oscillating electromagnetic field embodying a power and a clock signal. The RFID tag 180 detects the oscillating electromagnetic field output from the RF transceiver when the RFID tag 180 is in the range of the RF transceiver 170. Then, the RFID tag 180 inductively converts the energy of alternating electromagnetic field to a voltage that powers a microchip and memory of the RFID tag 180. The active RFID tag 180 returns a modulated analog signal having encoded data from its memory to the RF transceiver 170. The modulated RF signal is received by an antenna in the RF transceiver 170 and the signal is processed and converted to digital bit stream.

The subscription services may further embody barcodes 182 that can be easily read by a barcode reader 172 mounted with the RF transceiver 170. Barcode 182 may associate the RFID tag 180 with a particular subscription and/or with a particular customer. Barcodes 182 may also contain the same or different information than that encoded in the memory of the RFID tag 180. Barcode reader 172 reads the data encoded in the barcode 182.

The digital data stream resulting from the data originating in the RFID tag 180 is received and converted by the RF transceiver 180 is then sent to the local processor 160. The RF transceiver 170 is in communication with local processor 160 through any available communication system, such as through analog or digital wires such as busses 162, 164, 166 or through wireless communication. In some embodiments, the functionality of the local processor 160 may be integrated with the RF transceiver 170. Alternatively, local processor 160 may be physically located away from the RF transceiver 170. For instance, local processor 160 may be housed in weatherproof enclosure for mounting near the wash equipment 154, e.g., directly in the environment wherein vehicles are washed. An example of a local processor 160 is an embedded box computer available from ADVANTECH in Milpitas, Calif. Local processor 160 may also be included as an application within a stand-alone client computer 152 in the washing facility 150.

Local processor 160 may be configured to be in communication, either through a wired connection 140, 146 or a wireless connection 146 or the Internet 142, with host server 120 and/or with other multiple washing facilities 150 either through separate connections or through the host server 120. Washing facilities 150a, 150b, 150c may be in communication with each other on network 146 which may, for instance, be a washing facility Intranet. Network 146 may be a LAN, a WAN, an Intranet, a secure network through the Internet or a wireless network. Local processor 160 has several functions besides processing the digital data received from the RF transceiver 170; it connects the RF transceiver 170 to one or more external entities, such as a client computer or terminal 52 in this and/or other washing facilities 150, or other local processors 160 in remote washing facilities, or to kiosks 174 at any of the washing facilities 150. Local processor 160 thus may be connected to one or more communication interfaces 156 by, e.g., RS232, RS485, 802.x, Ethernet, wireless connections 164 for the exchange of data with entities within or external to the washing facility 150. Communication interface 156 may further be connected to network 146 which may be a business Intranet or a business LAN, as explained herein. In any event, the local processor 160 is directly or indirectly in communication with a host server 120 through a variety of optional connections described herein.

Local processor 160 has a central processing unit, RAM, ROM local storage capabilities such a hard disk drive or a flash memory connection, an operating system and application components necessary to execute its functions described herein. Local processor 160 preferably has a local data repository 148 having a subset of information contained in a host data repository 138 within host server 120. Local processor 160 further has logic to lookup and identify information received from the RFID tag 180 in order to, inter alia, log usage of the RFID tag 180, and report types and usage of subscription services at the washing facility 150 to the host server 120. Local processor 160 may further store subscription information about subscriptions that can only be used at a particular washing facility and/or about washing services that are unique to that washing facility, e.g., detailing a vehicle or a special waxing procedure may be offered at one washing facility but not at another, so local processor 160 will store this information and make it available for selection to a subscriber at the washing facility offering the service. Preferably, local processor 160 hosts a website and has application program and user interfaces to allow purchase of a subscription and activation of an RFID tag 180 for immediate use at that washing facility.

Washing facility 150 is capable of communicating with a host server 120, shown in FIG. 1. Host server 120 has a processor 118, appropriate application program interfaces to be described, and communication equipment including one or more network interfaces 122, such as an Ethernet card, and various applications 134, such as a browser, to connect to the Internet 142, an Intranet, or other network 146 to which washing facility 150 is also connected. Host server 120 may be in the same physical location as a washing facility 150 or may be physically located away from any or all of the washing facilities 150. Host server 120 capabilities may also be included in a local client 152.

Host server 120 is in communication with the local processor 160 at each washing facility 150. Host server 120 may further be connected to the washing facilities 150 via a corporate Intranet 140, 146 or through the Internet 142. Host server 120 has a central processing unit 118 connected by internal busses to various memories 132: a ROM; RAM, a number of applications 136 including application program and user interface applications, and the applications 134 to link and synchronize washing subscriptions. Host server 120 further has applications 134 for all data processing required in maintaining accurate customer and subscription records that rely on billing requests and other criteria to determine status. Host server 120 has a host database 138 that may be a relational database containing a complete set of data of the washing services, e.g., customer and subscription records, service history for a subscriber, all RFID tag identifiers and information, including barcodes, a listing of washing facilities, RFID tag history logs, error logs, types and costs of washing and subscription services, billing information and history, etc. The host server 120 preferably hosts a main website and corresponding application program interfaces and the user interfaces by which a subscription can be entered and many administrative components for adding and updating customer and subscription records, viewing usage logs as well as perform other administrative tasks, such as billing, centralized logging, maintaining the main data repository 138, and synchronizing the data repositories 148 of the local processors 160. Host server 120 preferably has applications 134 to provide security for subscription and customer data, including personal data, using, e.g., 3DES encryption of stored personal area networks (PANs) masking viewed PANs, erasure of unnecessary data after a period of time, not storing full track data, etc.

As will be appreciated by one skilled in the art, the present invention may be embodied as a system, method or computer program product for linking and synchronizing subscriptions for using washing facilities at multiple locations. Accordingly, the present invention may take the form of an entirely hardware embodiment, an entirely software embodiment (including firmware, resident software, micro-code, etc.) or an embodiment combining software and hardware components that may all generally be referred to herein as a circuit, module or system. Furthermore, the present invention may take the form of a computer program product embodied in any tangible medium of expression having components of computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the host server 120, partly on the local processor 160, and partly on the local client 152, or entirely on the host server 120 with certain components executing on the local processor 150. In the latter scenario, the host server 120 may be connected to the local processor 160 and/or the local client 154 through any type of network 140, 142, 146, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products having components according to embodiments of the invention. It will be understood that each block of the flowchart illustrations and/or block diagrams, and combinations of blocks in the flowchart illustrations and/or block diagrams, can be implemented by components having computer program instructions. These program components may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program components may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program components may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a component, module, segment, or portion of code, which comprises one or more executable instructions for implementing the specified logical function(s). It should also be noted that, in some alternative implementations, the functions of the components noted in the block may occur out of the order noted in the figures. For example, two components shown as successive blocks may, in fact, be executed substantially concurrently, or the components may sometimes be executed in the reverse order, depending upon the functionality involved. It will also be noted that each components of the block diagrams and/or flowchart illustration, and combinations of components in the block diagrams and/or flowchart illustration, can be implemented by special purpose hardware-based systems that perform the specified functions or acts, or combinations of special purpose hardware and computer instructions.

The components for linking and synchronizing subscriptions to obtain washing services across multiple washing facilities simultaneously and flexibly serves many customers and many washing facilities. The process software components can be stored on a shared file system accessible from the host server 120 or clients 152 located at the washing facilities 150 connected to the host server 120 and/or one or more local processors 160. Use of a particular subscription associated with an RFID tag 180 to obtain washing services can be processed anywhere in the system of washing facilities 150 that provide the shared execution of the process software components, but preferably in the host server 120. The total number of washing services that have actually been used by a subscriber are read by the RF technology at each washing facility 150 and are periodically synchronized among the host database 138 and the local databases 148. Linking and synchronization allow system information to be shared across the washing facilities 150. Subscription information such as remaining services available and washing services actually used may be sent to the subscriber according the terms of the subscription agreement. Through the hosted website, a subscriber may remit payment to the washing service provider, i.e., the company owning or having a franchise to the multiple washing facilities. In another embodiment, the washing service provider requests payment directly from a subscriber's account at a banking or financial institution, such as through an ACH transfer, PAYPAL, or other e-financial services.

Another aspect of the method and services described herein is for the business having the host server 120 to provide services to the washing facilities which nay include hosting a website offering subscription services, linking and synchronizing subscriptions, billing the washing facility organization for use of the host server 120 and its applications 134 directly or through an automatic payment method using the hosted or other website. Another way of looking at it is that the washing facility organization that provides washing services and washing subscriptions is a customer of the host server business providing the linking and synchronization applications 134 through the host server 120 or its distributed network. The host server 120 applications, moreover, may have the capability to reconcile payment owed by the washing services organization with accounts receivable of the washing services organization to minimize payment transactions.

The process software for linking and synchronizing washing subscriptions across multiple washing facilities may also be deployed, accessed and executed through the use of a virtual private network (VPN), which is any combination of technologies that can be used to secure a connection through an otherwise unsecured or untrusted network. For instance, with respect to FIG. 1, network 146 and 140 may actually be part of VPN through Internet 142. The use of VPNs improves security and reduces operational costs. The VPN makes use of a public network, usually the Internet, to connect remote sites or users together. Instead of using a dedicated, real-world connection such as leased line, the VPN uses virtual connections routed through the Internet from the company's private network to the remote site or employee.

When using the site-to-site VPN, the software components for synchronizing and linking are deployed, accessed and executed through the use of dedicated equipment and large-scale encryption provided by the host server 120 that are used to connect a multiple washing facilities over a public network such as the Internet. The process software is transported over the VPN via tunneling which is the process of placing an entire packet within another packet and sending it over a network. The protocol of the outer packet is understood by the network and both points, called tunnel interfaces, where the packet enters and exits the network.

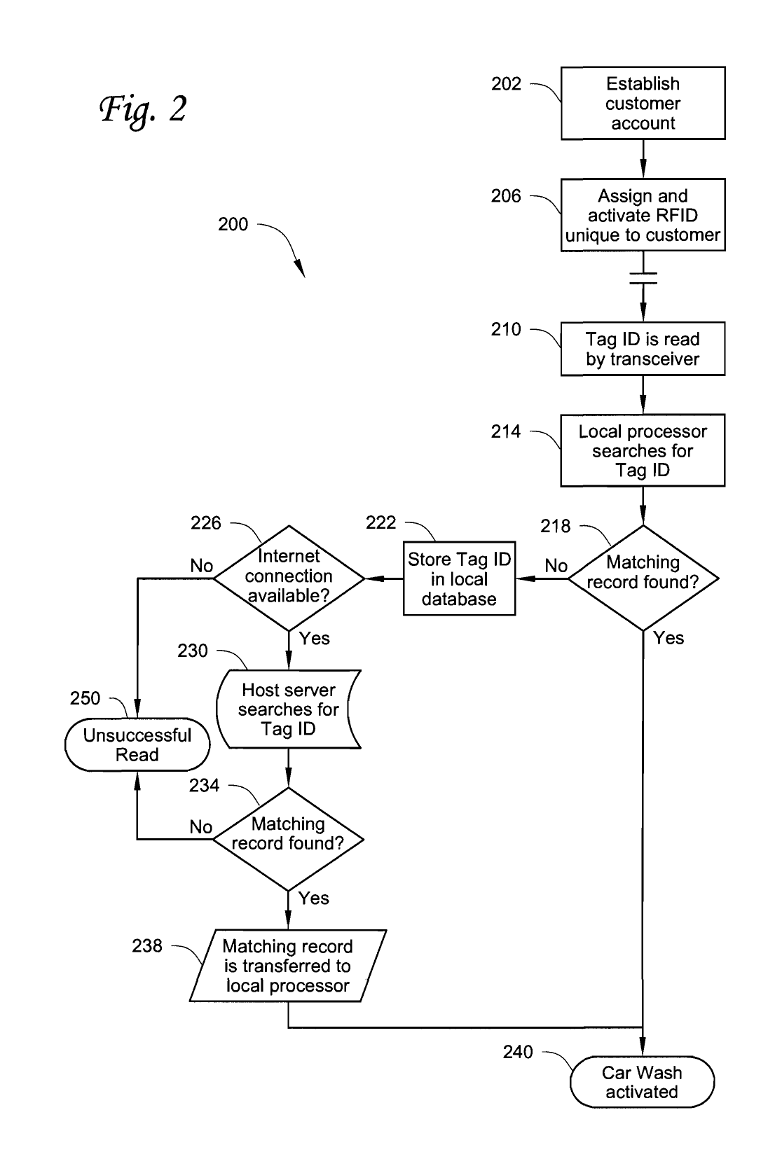

FIG. 2 provides a flow chart of one embodiment of a method 200 by which a customer directly enrolls in a subscription for washing services. Subscription enrollment may occur at a kiosk 174 at a washing facility 150, or through a user interface provided by the local client 152 within a customer service station at the washing facility. In step 202, a connection from the local processor 160, if the customer is enrolling at the kiosk 147, or from a local client 152 or from a remote computer such as the customer's own laptop, personal, or mobile computer is established to the host server 120. Enrollment data, such as a customer's name, payment information and the number and types of washing service subscriptions, may be input through any installed user or machine interface. Entry of payment information may be manual or read electronically from a customer's identification card or a payment card, such as a credit or debit card. Note that at this time, if enrollment occurred remotely by, e.g., access to the website hosted by host server 120, a customer's subscription is established in the host server 120. If enrollment occurred at a washing facility 150 either through the kiosk 174 or through input using the local client 154, the subscription is only established locally and has not been linked or synchronized with other washing facilities 150 through host server 120.

In step 206, the subscriber receives a unique and active RFID tag 180. For instance, if enrollment occurs at the kiosk 174, the local processor 160 can record the subscription and the RFID tag 180 information in its local data repository 148, activate, and dispense the RFID tag 180 through an output slot on the kiosk 174. If enrollment occurs through a customer service center at a washing facility, then a representative of the washing facility can activate and present the RFID tag 180 to the subscriber. If enrollment occurs remotely, the subscriber need only present proof of identification, or the credit/debit card, or proof of payment at the washing facility 150, and an active RFID tag 180 may be dispensed at the kiosk 174 or by a representative at the washing facility.

To request use of the washing facility 150 using the subscription services at a washing facility 150, the subscription information in a new or an existing RFID tag 180 is read in step 210 by the RF transceiver 170 and converted to digital data and transmitted to the local processor 160 in, e.g., an XML format over an Ethernet connection. In step 214, a matching component executing with the local processor 160 searches for matching subscription data in its local data repository 148. At step 218, if an established record in local data repository 148 matches subscription information on the RFID tag 180, the subscriber's subscription information is updated in the local data repository 148. Information in a RFID tag 180 can be associated with a record in the local data repository 148 in one or more database fields, e.g., matching an identification number from the RFID tag 180, matching information contained in the barcode 182, matching information associated with the subscriber, etc. It is preferred that the RFID tag 180 be read for obtaining washing services, but the matching component herein allows for manual entry of subscription information so that the RFTD technology can be overridden and the washing services can still be rendered in accordance with the subscription and the transaction will be recorded in the local repository 148. If the subscription data associated with the RFID tag is not within the local repository 148 then, in step 240, a subscriber is authorized to use the washing facilities.

If, however, in step 218 no matching record is found in the local data repository 148 of the local processor 160 or in a database of local client 152 at the washing facility 150, then in step 222, the data of the RFID tag 180 is stored in the local data repository 148. In step 226 a connection component attempts to establish a connection to the host server 120. If communication cannot be established, the subscriber may be given an communication error that the host server 120 could not be found or other message, e.g., HTTP 404 error, that the services are unable to complete, as in step 250.

If, however, in step 226 a connection is established between the local processor 160 and/or the local client 152, a request for verification of the RFID tag 180 is transmitted to the host server 120. In step 230, a search component executing in the host server 120 searches the host database 138 for matching data in any of its fields based on data obtained from the RFID tag 180. If at step 234, a matching record is found in the host data repository that has information associated with that unique RFID tag 180, the host server 120 transmits a copy of the matching record to the local processor 160 and/or the local client 152 in step 238. The washing subscription associated with the RFTD tag 180 is activated in step 240.

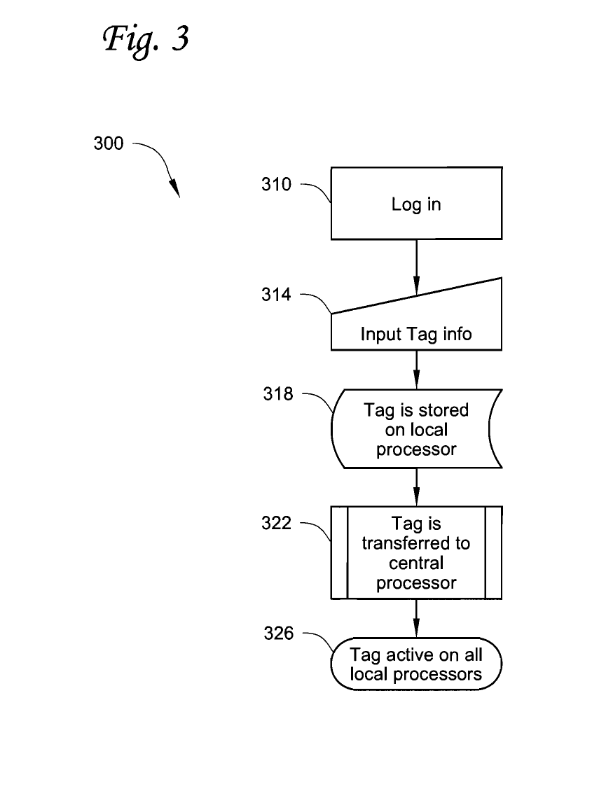

In this instance, the subscription is initially active only at the washing facility 150a. In order to activate the subscription at other washing facilities 150b, 150c, the local processor 160 will need to send subscription and its associated RFID tag 180 information to host server 120 for linking and synchronizing to all washing facilities 150. Process steps of the linking component 300 are presented in FIG. 3. Linking component 300 may execute within any of the processors described herein, i.e., within the local processor 160, within local client 152, and/or within the host server 120. Linking begins at step 310 wherein a customer or a local representative logs into either a website hosted either by local processor 160 or the local client 150 of the washing facility through a user interface. In step 314, identification associated with the RFID tag 180, such as an identification number or the barcode 182, is input and in step 318, the input data is stored in the local repository 148. The washing subscription associated with the RFID tag 180 is now active at the local washing facility. In step 322, during execution of the synchronization component (to be discussed), the subscription and RFID tag 180 information is transmitted to the host database 138 of the host server 120, and in step 326 the subscription of that RFID tag 180 will be linked to and will be active at all washing facilities that are connected to the host server 120.

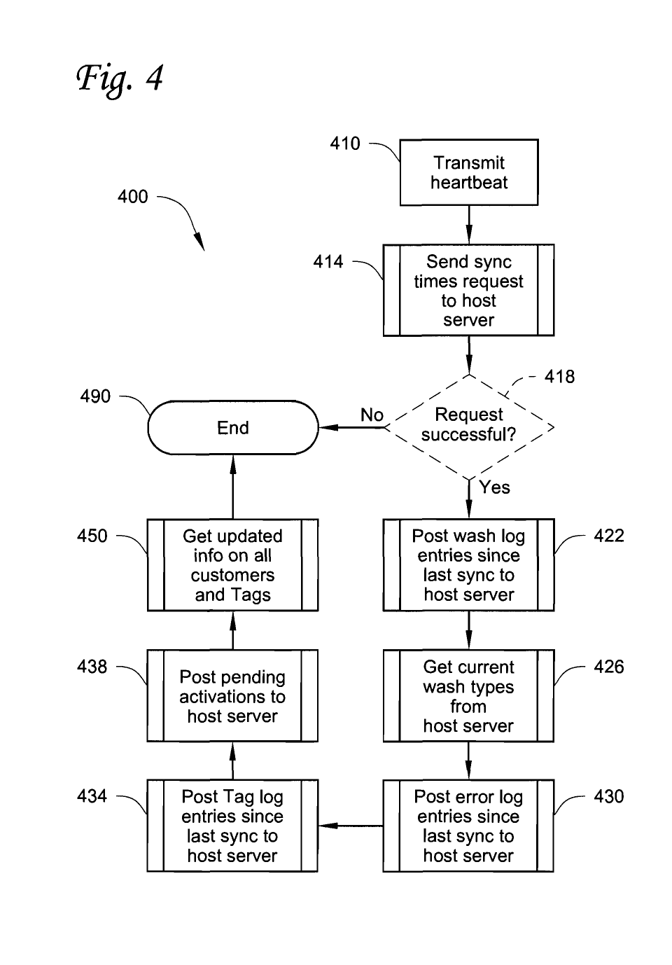

The process steps of the synchronization component 400 are shown in FIG. 4. Synchronizing the host database 138 with the information stored in all of the local data repositories 148 of connected washing facilities 150 may involve two steps: issuing a heartbeat, and initializing and executing the synchronization component.

First, the local processor 160 initiates and transmits a heartbeat to the host server 120 to inform the host server 120 that it is online and wants to access the host server 120, shown as step 410. The heartbeat may be a high or low pulse width of a minimum of fifty milliseconds, although the heartbeat may be configured with different values so long as the host server 120 recognizes the signal as a heartbeat. Once the heartbeat is received and acknowledged by the host server 120, it may return data required for synchronizing the date and time of the local processor 160 with the host server 120, initiating a restart of the remote administration capability, initiating a restart of the local processor 160, and initiating synchronization.

Synchronization may be initiated by the local processor 160 through the heartbeat or may occur on a regular basis or as needed taking into account system utilization levels to ensure that the subscriptions and other data of the washing facility system are current and correct. Once the host server 120 is receptive to the local processor 160, the local processor 160 in step 414 sends a request to the host server 120 to retrieve the date of the last synchronization and the entry date of the most recent logs received from the local processor 160. In step 481, a confirmation component determines if the request was successfully received by the host server 120. If not, the synchronization process will abort in step 490.

Once a connection from the local processor 160 has been established with the host server 120 and past synchronization and log dates has been transmitted to the local processor as in step 414, and then in step 422, the local processor 160 transmits all subscription and washing facility log information having a date after the last log entry and/or synchronization date to the host server 180. Of course, using a date to determine which log and subscription data is transmitted to the host server 120 is only one parameter by which the data may be transferred; other factors to determine the number and frequency of synchronizations may be, e.g., the number of transactions, occurrence of specific events may require an immediate synchronization or notification, such as an attempt to use an unauthorized subscription or an unauthorized service, problems with the local processor 160, problems with the washing equipment 154, etc.

After the local processor 160 and the host server 120 have negotiated that synchronization will occur and determined what logs and records will be synchronized, the actual synchronization begins in step 426 with the local processor 160 downloading from the host server 120 its washing services, including adding new washing services and removing obsolete washing services. In step 430, any errors that have occurred in the washing facility and logged by the local processor and/or error logs and subscription records are transmitted from the local processor 160 to the host server 120, as determined by the synchronization parameters.

In step 434, log entries of RFID tags 180 and subscriptions that do not exist in the host database 138 are transmitted from the local processor 160 to the host server 120 depending upon the parameters of the synchronization process, e.g., dates, events, specific RFID identification or barcode readings, etc. In step 438, all pending subscriptions having a newly activated RFID tag 180 that were initiated at the washing facility 150 and recorded in the local database 138 are transmitted to the host server 120. Then, in step 450, the host server 120 downloads not only current information on subscriptions and RFID tag 180 information but also new subscription and RFID tag 180 information that were registered or activated either remotely or at other washing facilities 150b, 150c, as well as deactivated or expired subscriptions and RFID tag 180 information.

Upon successful execution of the synchronization component 400, the local processor 160 will have current record of all subscriptions within the host database 138 in its own local data repository 149. Local usage logs, stored in the local data repository 148, are transmitted to the host server 120 and the usage logs on in the local repository 138 are truncated to maintain efficiency. Host server 120 stores any new subscriptions and associated RFID tag 180 information in the host database 138.

As explained herein, synchronization occurs between the host server 120 and local processors 160 at all washing facilities, but need not be so limited. There may be synchronization using the local client 152 as an intermediate backup storage and processing so that, for example, synchronization between the local processor 160 and the local client 152 may occur on a more frequent basis and independent of any synchronization between the local client 152 and the host server 120 and/or other clients 152 at other washing facilities.

In one embodiment, the host server and its subscription and synchronization services may be leased and/or purchased from a host service provider to provide these services to one or more businesses having multiple washing facilities. In these instances, quality-of-service issues are important and can be provided on the basis of the service parameters purchased. For instance, a business having multiple washing facilities desiring guarantees of data and transmission security, storage capacity, bandwidth, availability of host server 120 and the frequency and amount and types of logs for linking and synchronization may pay more than a washing facility or subscription business having fewer washing facilities, fewer subscriptions that may not require the availability of host server 120 at all times such that the washing facilities need not be online as much and synchronization need not be as frequent, etc. Those skilled in the art of providing computer-implemented services across a network will understand that other quality-of-service parameters can vary across washing facility and/or subscription businesses.

While the disclosed system and method have been described in conjunction with a preferred embodiment of washing facilities, it will be obvious to one skilled in the art that other objects and refinements of the disclosed system and method may be made within the purview and scope of the disclosure. The disclosure, in its various aspects and disclosed forms, is well adapted to the attainment of the stated objects and advantages of others. The disclosed details are not to be taken as limitations on the disclosed system and method but the scope of the invention will be determined by the claims and their equivalents as presented below.

What is claimed is:

1. A method of providing washing services, comprising:
establishing a subscription for washing services to be provided at one or more washing facilities;
linking the subscription with a first identifier;
reading subscription data associated with the first identifier;
determining that a record of the first identifier exists in a local database at the one or more washing facilities; and
authorizing washing services in accordance with the subscription.

2. The method of providing washing services as in claim 1, further comprising:
associating the first identifier with a first record in the local database if the record of the first identifier does not exist in the local database.

3. The method of providing washing services as in claim 2, further comprising:
transmitting the first record associated with the first identifier to a host database.

4. The method of providing washing services as in claim 3, further comprising:
synchronizing subscription data and respective first identifiers of a plurality of first records stored in the host database with one or more records in a local database of others of the one or more washing facilities.

5. The method of providing washing services as in claim 4, further comprising;
authorizing washing services in accordance with subscription data at the others of the one or more washing facilities.

6. The method of providing washing services as in claim 1, wherein the first identifier comprises an RFID tag and a barcode, the barcode associating the RFID tag with the subscription data.

7. The method of providing washing services as in claim 6, wherein the RFID tag is mounted on a vehicle to be washed in the one or more washing facilities.

8. The method of providing washing services as in claim 6, wherein the first identifier comprises a smartcard.

9. A method of maintaining a plurality of subscriptions for washing services, comprising:
issuing a plurality of mobile identification devices having data therein;
linking a subscription of washing services to a respective one of the plurality of mobile identification device;
storing a linked record of each linked subscription and its respective mobile identification device at a local washing facility; and
storing a use record of each use of the mobile identification device to obtain washing services at the local washing facility.

10. The method of maintaining a plurality of subscriptions for washing services of claim 9, wherein the mobile identification device is one selected from the group consisting of: a radiofrequency tag, a smartcard, an identification card, a financial services card, a license plate tag, a piece of paper.

11. The method of maintaining a plurality of subscriptions for washing services of claim 9, further comprising:
copying the stored records to a host database in a host server in communication with a plurality of washing facilities comprising the local washing facility.

12. The method of maintaining a plurality of subscriptions for washing services of claim 11, further comprising:
copying the stored records to the plurality of washing facilities.

13. The method of maintaining a plurality of subscriptions for washing services of claim 12, further comprising:
synchronizing the stored records among the plurality of washing facilities and the host database.

14. The method of maintaining a plurality of subscriptions for washing services of claim 13, further comprising:
updating the use records of each mobile identification card to obtain washing services at the plurality of washing facilities in accordance with its linked subscription.

15. The method of maintaining a plurality of subscriptions for washing services of claim 14, further comprising:
updating the subscription linked to each mobile identification card based on the updated use records to determine the validity of the subscription.

16. The method of maintaining a plurality of subscriptions for washing services of claim 13, further comprising:
synchronizing the plurality of subscriptions with updated washing services.

17. The method of maintaining a plurality of subscriptions for washing services of claim 13, further comprising:
logging use of washing services provided at each of the washing facilities and storing a log of the use in the host database.

18. The method of maintaining a plurality of subscriptions for washing services of claim 10, wherein the host server presents a plurality of web-based user interfaces for interacting with a plurality of washing service applications on the host server, the washing service applications comprising one or more of the following:
providing a web-based user interface at each of the plurality of washing facilities for transmitting events relating to operations of the respective washing facility to the host server;
adding and deleting subscriptions to washing services;
monitoring use of subscriptions;
billing a customer responsible for each subscription based on use of the subscription;
changing washing services;
monitoring a plurality of operation logs stored on the host server of the plurality of washing facilities; and
monitoring a plurality of subscription logs stored on the host server of the plurality of washing facilities.

19. A computer program product to synchronize and link a plurality of washing subscriptions, comprising:
a computer-readable medium; and
program instructions residing in the computer-readable medium of an issuance component for issuing a plurality of mobile identification devices having data therein;
program instructions residing in the computer-readable medium of a linking component to link a subscription of washing services to a respective one of the plurality of mobile identification device;
program instructions residing in the computer-readable medium of a storage component to store a linked record of each linked subscription and its respective mobile identification device at a local washing facility and a use record of each use of the mobile identification device to obtain washing services at the local washing facility;
program instructions residing in the computer-readable medium of a transfer component to copy the stored records to a host database in a host server in communication with a plurality of washing facilities comprising the local washing facility and to the plurality of washing facilities;
program instructions residing in the computer-readable medium of a synchronization component to synchronize the stored records among the plurality of washing facilities and the host database; and
program instructions residing in the computer-readable medium of a usage monitoring component to update the use records of each mobile identification card to obtain washing services at the plurality of washing facilities in accordance with its linked subscription and to update the subscription linked to each mobile identification card based on the updated use records to determine the validity of the subscription.

20. A computer program product comprising:
a computer-readable medium; and
program instructions residing in the computer-readable medium to provide a plurality of services to a plurality of washing facilities, further comprising:
program instructions residing in the computer-readable medium of at least one communications component to create communications among the plurality of washing facilities;
program instructions residing in the computer-readable medium of a synchronization component to synchronize a plurality of subscriptions for washing services with updates of washing services offered at the washing facilities;
program instructions residing in the computer-readable medium of a logging component to log use of washing services provided at each of the washing facilities and store a log of the use in a database;
program instructions residing in the computer-readable medium of a web-based interface whereby the plurality of washing facilities have access to a plurality of service applications having program instructions residing in the computer-readable medium of one or more of the following:
program instructions residing in the computer-readable medium of a web-based user interface at each of the plurality of washing facilities for transmitting events relating to operations of the respective washing facility to the host server;
program instructions residing in the computer-readable medium of a subscription component to add, delete and monitor use of subscriptions to washing services;
program instructions residing in the computer-readable medium of an accounts receivable component to bill a customer responsible for each subscription based on use of the subscription;
program instructions residing in the computer-readable medium to reprogram washing services available at each of the washing facilities;
program instructions residing in the computer-readable medium of a logging component to store a plurality of subscription logs reflecting use of and data for each subscription and a plurality of operational logs of a plurality of operational event of each of the plurality of washing facilities.
